(19) United States
(12) Patent Application Publication
(10) Pub. No.: US 2015/0027091 A1
(43) Pub. Date: Jan. 29, 2015

(54) Fiber Reinforced Polymer (FRP) Structural Media Support for Odor Control Tank System

(71) Applicant: Daniel A. Witcher, Bristol, TN (US)

(72) Inventor: Daniel A. Witcher, Bristol, TN (US)

(73) Assignee: Enduro Composites, Inc, Houston, TX (US)

(21) Appl. No.: 13/987,465

(22) Filed: Jul. 29, 2013

(51) Int. Cl. B01D 46/00

(52) U.S. Cl. CPC B01D 46/0005; B01D 46/0038
USPC 55/358

(57) ABSTRACT

A structural media support is a system of Glass-Fiber Reinforced Polymer (G-FRP) members consisting of beams, columns and bracing together with an FRP grating grid for supporting filter media within a G-FRP odor control tank vessel. The odor control system receives odorous air flow into a plenum and via differential pressures within the system forces the air through a filter media for the degradation of the specific odorous compounds that accumulate on the media. Filtered air exits the media to a second plenum and is expelled from the tank vessel. The media support is a free-standing structural system within the tank vessel that is attached to the tank vessel floor through free-standing columns.

### CROSS REFERENCE TO RELATED APPLICATIONS

None

### FIELD OF THE INVENTION

The present invention relates to structural support systems of filtration media in odor control systems.

### BACKGROUND OF THE INVENTION

Structural support systems for media filtration in odor control units are used where ever an open plenum beneath the media is required within the system. Such support systems need to be capable of support the weight of the media and transfer the loads into the tank vessel floor which in normal installations is resting upon and anchored to a base slab or foundation.

The free-standing nature of this system wherein the loads from the media support structure are not distributed into the tank vessel walls eliminates heavy reinforcement in the tank vessel walls and then into the tank base and foundation. This method is proven to be a more efficient structural system than utilizing the tank vessels walls to act as a monolithic structural system.

The diameter of the system is limited to 14 Feet as this is the largest vessel tank that can be transported and shipped commercially.

### BRIEF DESCRIPTION OF THE DRAWINGS

FIG. 1. is a plan view of media support—14 Foot maximum diameter tank vessel.

FIG. 2. is a cross-sectional view of media support—14 Foot maximum diameter tank vessel taken from FIG. 1 at the support columns showing the G-FRP vertical angle bracing and connection elements

FIG. 3. is a plan view of media support—10 Foot maximum diameter tank vessel.

FIG. 4. is a cross-sectional view of media support—10 Foot maximum diameter tank vessel taken from FIG. 3 at the support columns showing the G-FRP vertical angle bracing and connection elements.

FIG. 5. is a plan view of media support—6 Foot maximum diameter tank vessel.

FIG. 6. is a cross-sectional view of media support—6 Foot maximum diameter tank vessel taken from FIG. 5 at the support columns showing the G-FRP vertical angle bracing and connection elements.

### DETAILED DESCRIPTION

To efficiently optimize the structural support required within the varying tank vessel diameters utilized in odor control systems necessitates that several lay-out configurations and a selections of structural members be utilized. Given that for an odor control system to be manufactured and most cost effectively installed the tank vessels must be of the size that can be transported to the utility site via public highways and streets. Optimization is achieved when most of the manufacture and assembly of the odor control vessel units can be done in the manufacturing facility. These objectives are most reasonably achieved by limiting the tank vessel diameter to 14 Feet or less. Further optimization of material utilization within the components is possible by considering a range of diameters. This invention considers three size ranges in diameters of less than 6 Feet, diameters of 6 Feet to 10 Feet, and diameters of 10 Feet to 14 Feet.

G-FRP (glass-fiber reinforced polymer) is the material of choice in most odor control systems as it has a high strength to weight ratio and is corrosive resistant in the environments served. Structural members (beams, columns and connecting elements) that comprise the primary support frames are manufactured from the pultrusion process that consists of pulling a fiber-reinforcement (glass in this use) through a resin impregnation bath (vinyl ester or polyester) and then through a shaping die. The grating grid which supports the media filter material is composed of either pultruded grating bars assembled into a grid using interlocking cross-rods or is cast molded into cross-grid panels. Open area within the grating grid system varies between 35% and 50% depending on the particular structure members, type of grating, and the diameter of the tank vessel.

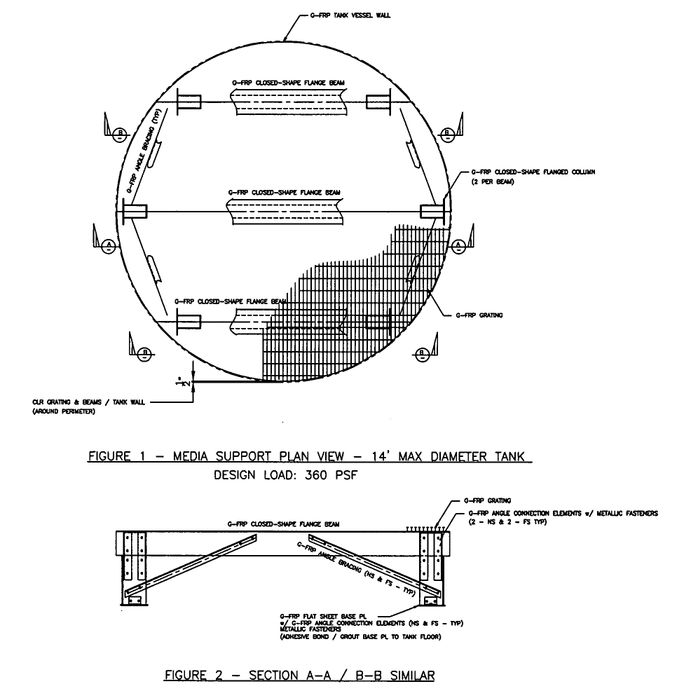

FIGS. 1 and 2 are of the largest of the structural media supports used in commercially shippable round tanks (10 Ft.-14 Ft. diameter). This configuration utilizes G-FRP closed-shaped flanged (boxed) members for the primary structure. These members are 12 inches deep (top flange to base of box or bottom flange). Web elements of these members are 0.25 inches thick and are positioned 6.5 inches outside-face-to-outside face. The top flange (outside flange in columns) is 0.38 inches thick and 12 inches wide.

FIG. 1 is a plan view of the tank vessel and structural media G-FRP support grating grid (partially shown) and the G-FRP beam and column support structure beneath the grating. The G-FRP closed-shaped columns (6 required) are adhesive bonded to the tank floor and are connected to the bottom face of the G-FRP closed-shaped beams (3 required) using G-FRP angle connection elements with metallic fasteners (stainless steel bolts, nuts and washers). The G-FRP flat sheet base plate is attached to the column base by utilizing G-FRP angle connection elements with metallic fasteners. The column is cut square to bear against the underside of the beam and against the base plate. G-FRP bracing in the horizontal and in the vertical planes between columns is utilized to lateral brace the support structure to stabilize the structure and to resist any applied lateral loads. FIG. 2 shows a detail of the bracing and connection elements at the columns. These connections also use metallic fasteners.

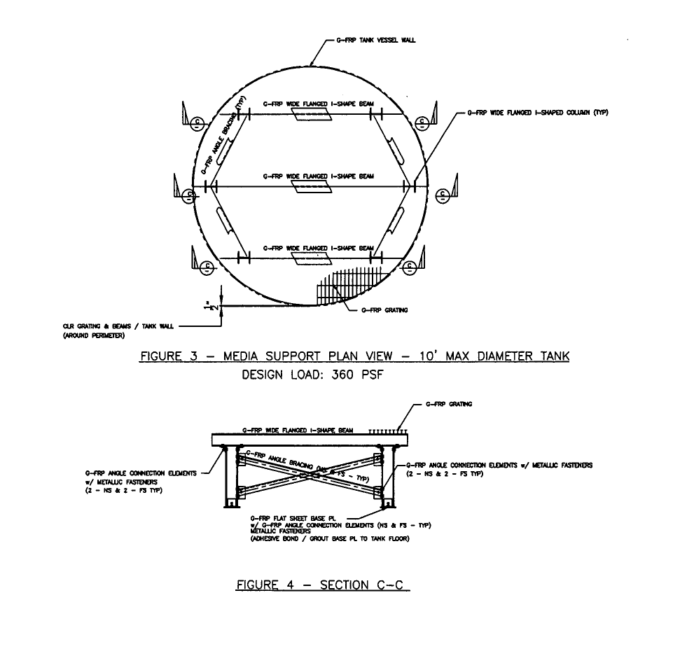

FIGS. 3 and 4 are of the mid-sized of the structural media supports (6 Ft. to 10 diameter). This configuration utilizes G-FRP wide flanged I-shaped members for the primary structure. These members are 6 inches deep (top flange to bottom flange—exterior faces). The flanges are 0.38 inches thick and 6 inches wide and single web element is 0.38 inches thick.

FIG. 3 is a plan view of the tank vessel and structural media G-FRP support grating grid (partially shown) and the G-FRP beam and column support structure beneath the grating. The G-FRP wide flanged I-shaped columns (6 required) are adhesive bonded to the tank floor and are connected to the bottom face of the G-FRP wide flanged I-shaped beams (3 required) using G-FRP angle connection elements with metallic fasteners (stainless steel bolts, nuts and washers). The G-FRP flat sheet base plate is attached to the column base by utilizing G-FRP angle connection elements with metallic fasteners. The column is cut square to bear against the underside of the beam and against the base plate. G-FRP bracing in the horizontal and in the vertical planes between columns is utilized to lateral brace the support structure to stabilize the structure and to resist any applied lateral loads. FIG. 4 shows a detail of the bracing and connection elements at the columns. These connections also use metallic fasteners.

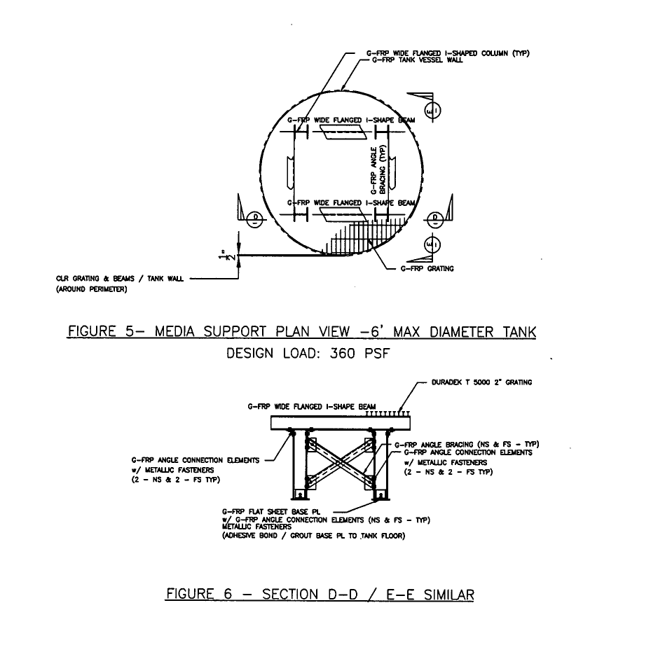

FIGS. 5 and 6 are of the minimum sized structural media supports (6 Ft. and less diameter). This configuration also utilizes G-FRP wide flanged I-shaped members for the primary structure. These members are 6 inches deep (top flange to bottom flange—exterior faces). The flanges are 0.38 inches thick and 6 inches wide and single web element is 0.38 inches thick.

FIG. 5 is a plan view of the tank vessel and structural media G-FRP support grating grid (partially shown) and the G-FRP beam and column support structure beneath the grating. The G-FRP wide flanged I-shaped columns (4 required) are adhesive bonded to the tank floor and are connected to the bottom face of the G-FRP wide flanged I-shaped beams (2 required) using G-FRP angle connection elements with metallic fasteners (stainless steel bolts, nuts and washers). The G-FRP flat sheet base plate is attached to the column base by utilizing G-FRP angle connection elements with metallic fasteners. The column is cut square to bear against the underside of the beam and against the base plate. G-FRP bracing in the horizontal and in the vertical planes between columns is utilized to lateral brace the support structure to stabilize the structure and to resist any applied lateral loads. FIG. 6 shows a detail of the bracing and connection elements at the columns. These connections also use metallic fasteners.

Modifications to these lay-outs can accommodate nozzles, access-ways and other elements in the tank vessel walls as necessary by rotating structure within the tank vessel during assembly. A structural engineer should be involved in the final determination of utilization of this invention as it relates to specific site conditions and applied loads as may be applicable.

1. A structural support for filter media within an odor control tank vessel consists of: G-FRP structural beams connected with G-FRP components and metallic fasteners, G-FRP columns supporting the G-FRP beams connected to the beams with G-FRP components and metallic fasteners, G-FRP lateral and vertical bracing between the beams and columns connected with G-FRP components and metallic fasteners and adhered to the tank floor with structural adhesives, and a G-FRP grating grid connected to the support beams with metallic grating clips. Various media can be supported by the structure and grating.

2. The structural support of claim 1, wherein is used in round G-FRP tank vessels up to and including 14 Feet diameter.

3. The structural support of claim 1, wherein is capable of supporting a uniform distributed media weight of up to 360 pounds per square foot.

4. The structural support of claim 1, wherein utilizes G-FRP Wide flanged I-shaped beams or closed-shape flanged beams depending on the diameter of the tank vessel and media weight being supported.

5. The structural support of claim 1, wherein utilizes G-FRP Wide flanged I-shaped columns or closed-shape flanged columns depending on the diameter of the tank vessel and media weight being supported.

6. The structural support of claim 1, wherein utilizes at the base of the G-FRP columns G-FRP connection angles and metallic fasteners, wherein a G-FRP flat sheet base plate is bolted with metallic fasteners to the column via the connection angles.

7. The structural support of claim 1, wherein utilizes G-FRP angle connection elements and metallic fasteners to interconnect the G-FRP beams and G-FRP columns.

8. The structural support of claim 1, wherein utilizes G-FRP angle bracing and G-FRP angle connection brackets.

9. The structural support of claim 1, wherein utilizes G-FRP pultruded G-FRP grating or cast molded G-FRP grating configured to be positioned within the interior diameter of the tank vessel and to be supported by the G-FRP beams directly beneath the grating and wherein the grating is attached to the beams with metallic grating clips configured for the particular grating type.
